(19) United States
(12) Patent Application Publication
(10) Pub. No.: US 2026/0268618 A1
(43) Pub. Date: Sep. 10, 2026

(54) LINEAR CAGE DEFORMER FOR MULTI-LAYERED OUTFITS

(71) Applicant: Roblox Corporation, San Mateo, CA (US)

(72) Inventors: Adam Tucker BURR, San Mateo, CA (US); Alexander EHRATH, San Mateo, CA (US)

(73) Assignee: Roblox Corporation, San Mateo, CA (US)

(21) Appl. No.: 18/875,514

(22) PCT Filed: Aug. 13, 2024
(86) PCT No.: PCT/US2024/042102

§ 371 Date: Dec. 16, 2024

Related U.S. Application Data
(60) Provisional application No. 63/532,621, filed on Aug. 14, 2023.

(51) Int. Cl. G06T 19/20; G06T 17/20

(52) U.S. Cl. CPC G06T 19/20; G06T 17/20; G06T 2210/16; G06T 2219/2004; G06T 2219/2021

(57) ABSTRACT

A linear cage deformer for multi-layered outfit technique is used to fit arbitrary three-dimensional (3D) geometry to arbitrary target 3D geometry for 3D avatars in a 3D environment. For multi-layered clothing, an iterative procedure is applied to determine differences between successive clothing layers and then accumulate these differences to create a final layered effect. Some implementations relate to methods, systems, and computer-readable media to provide such 3D avatars with multi-layered clothing by providing the avatar, the avatar having an avatar body to be layered with an inner garment and an outer garment. The inner garment may be layered onto the avatar body and the outer garment may be layered onto the inner garment. Such layering may include fitting garments and deforming outer cages of the garments using a linear cage deformer technique. After the layering, the avatar body is rendered with the garments.

### CROSS-REFERENCE TO RELATED APPLICATIONS

This application is a § 371 national stage of PCT International Application No. PCT/US2024/042102, filed Aug. 13, 2024, entitled “LINEAR CAGE DEFORMER FOR MULTI-LAYERED OUTFITS,” which claims priority to U.S. Provisional Application No. 63/532,621, entitled “LINEAR CAGE DEFORMER FOR MULTI-LAYERED OUTFITS,” filed on Aug. 14, 2023, the content of which are incorporated herein in their entirety.

### TECHNICAL FIELD

This disclosure relates generally to computer graphics, and more particularly but not exclusively, relates to methods, systems, and computer readable media to provide graphical representations of multi-layered clothing over an underlying graphical object using a linear cage deformer technique.

### BACKGROUND

Multi-user electronic gaming environments often involve the use of avatars, which represent the players in a virtual experience. Avatars are often three-dimensional (3D) avatars that differ in geometry, shapes, and styles from one avatar to another. For example, avatars may have different body shapes (e.g., tall, short, muscular, thin, male, female, human, animal, alien, etc.), numbers and types of limbs, and are customizable with multiple pieces of clothing/outfits and/or accessories worn by the avatar (e.g., shirt worn over the torso, jacket worn over the shirt, scarf worn over the jacket, hat worn over the head, etc.).

To provide clothing and/or accessories for avatars, game developers traditionally use radial basis functions (RBF) to reshape the garment outer cages. The RBF interpolation and extrapolation are essential for modeling continuous spatial data. However, extrapolation can lead to artifacts that diminish image quality.

When single layer distortions are applied to the garment outer cages on a multi-layer outfit, each layer's new outer cage is computed via the RBF technique for the next outer cage, so single layer distortions compound and get amplified as more layers are added. Hence, the shape of the outfit can be noticeably distorted, and in some cases, the outfit can explode or become enormous.

### SUMMARY

Implementations of the present disclosure relate to techniques of using a linear cage deformer for improved fitting and rendering of multi-layered clothing accessories for three-dimensional (3D) avatars. Such a linear cage deformer may reduce bulkiness that otherwise affects multi-layered clothing and may produce more visually pleasing and realistic looking avatars. The linear cage deformer may be especially effective for rendering an avatar wearing two or more layers of clothing.

For example, the techniques may include providing an avatar in a 3D virtual environment, the avatar having an avatar body to be layered with an inner garment and an outer garment. The inner garment may be layered onto the avatar body, the layering including fitting the inner garment onto the avatar body and deforming an outer cage of the inner garment using a linear cage deformer technique.

Then, the outer garment may be layered onto the inner garment, the layering including fitting the outer garment onto the inner garment and deforming an outer cage of the outer garment using a linear cage deformer technique. After the layering, the avatar body may be rendered with the inner garment and the outer garment layered thereon. The linear cage deformer technique may perform various operations to deform the outer cages of successive garments based on techniques that operate on inner cages of the garments and outer cages of corresponding previous garments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to provide a three dimensional (3D) avatar with multi-layered clothing in a 3D virtual environment is provided, the computer-implemented method comprising: providing the avatar in the 3D virtual environment, the avatar having an avatar body to be layered with an inner garment and an outer garment; layering the inner garment onto the avatar body, wherein the layering includes: fitting the inner garment onto the avatar body; and deforming, using a linear cage deformer technique, an outer cage of the inner garment based on one or more of an outer cage of the avatar body and an inner cage of the inner garment; layering the outer garment onto the inner garment, wherein the layering includes: fitting the outer garment onto the inner garment based on the deformed outer cage of the inner garment and an inner cage of the outer garment; and deforming, using the linear cage deformer technique, an outer cage of the outer garment based on one or more of the deformed outer cage of the inner garment and the inner cage of the outer garment; and rendering the avatar body with the inner garment and the outer garment layered thereon.

Various implementations of the computer-implemented method are described herein.

In some implementations, deforming the outer cage of the inner garment comprises: identifying, for at least one outer cage vertex of the outer cage of the inner garment, a single corresponding vertex on both the outer cage of the avatar body and on the inner cage of the inner garment; generating, using triangles that share the single corresponding vertex, a local coordinate frame of the inner cage of the inner garment and a local coordinate frame of the outer cage of the avatar body; and adjusting a position of the at least one outer cage vertex of the outer cage of the inner garment to deform the outer cage of the inner garment using a difference between the local coordinate frame of the inner cage of the inner garment and the local coordinate frame of the outer cage of the avatar body.

In some implementations, deforming the outer cage of the inner garment causes the outer garment to conform to a shape of the avatar body and a shape of the fitted inner garment.

In some implementations, the outer cage of the inner garment, the inner cage of the outer garment, and the outer cage of the outer garment share a standardized UV layout usable to determine correspondence information between the outer cage of the inner garment and the inner cage of the outer garment, and deforming the outer cage of the outer garment is based on the correspondence information.

In some implementations, the computer-implemented method further comprises: identifying, for at least one outer cage vertex of the outer cage of the outer garment, a single corresponding vertex on both the outer cage of the inner garment and on the inner cage of the outer garment; generating, using triangles that share the single corresponding vertex, a local coordinate frame of the inner cage of the outer garment and a local coordinate frame of the outer cage of the inner garment; and adjusting a position of the at least one outer cage vertex of the outer cage of the outer garment to deform the outer cage of the outer garment using a difference between the local coordinate frame of the inner cage of the outer garment and the local coordinate frame of the outer cage of the inner garment.

In some implementations, adjusting the position of the at least one outer cage vertex of the outer cage of the outer garment preserves an original spacing and alignment between the inner cage of the outer garment and the outer cage of the outer garment while deforming the outer cage of the outer garment.

In some implementations, deforming the outer cage of the inner garment using the linear cage deformer technique comprises: determining a first dataset that describes a volume taken up by the avatar body prior to the fitting the inner garment onto the avatar body and a second dataset that describes a volume taken up by the inner garment after the fitting over the avatar body; calculating differences between corresponding values in the first dataset and in the second dataset; and using sums calculated from the differences and the values in the second dataset to deform the outer cage of the inner garment.

In some implementations, if there are three or more layers of garments, the computer-implemented method further comprises, for each layer: iteratively calculating successive differences in volume between preceding successive garment layers; accumulating the successive differences; and deforming the layer based on the accumulated successive differences.

In some implementations, the linear cage deformer technique comprises, to deform an outer cage of a garment based on an outer cage of a previous garment or avatar body portion: iterating over garment cage triangles of the garment and summing vertex offsets and weights of the garment cage triangles; and deforming the outer cage of the garment based on a deformed garment outer cage (GOC) position determined from iterating over vertices of the outer cage of the garment.

In some implementations, iterating over garment cage triangles of the garment and summing vertex offsets and weights of the garment cage triangles comprises: computing difference transforms from previous outer cage (POC) triangles of the previous garment or avatar body portion to corresponding garment inner cage (GIC) triangles of the garment; and transforming vertices of GOC triangles of the garment based on corresponding difference transforms and updating vertex offsets and weights of the GOC triangles of the garment accordingly.

In some implementations, computing difference transforms from the POC triangles of the previous garment or avatar body portion to corresponding GIC triangles comprises computing local three by three matrices for the POC triangles and local three by three matrices for the GIC triangles, and the difference transforms are local difference (LD) three by three matrices calculated by multiplying the POC matrices by inverses of the GIC matrices.

In some implementations, computing the local three by three matrices for POC and GIC triangles comprises, for corresponding triangles of the POC and GIC triangles: finding a first vector and a second vector, where the first vector and the second vector are two triangle edges of the corresponding triangle; finding a third vector that is a cross product of the first vector and the second vector; normalizing the first vector, the second vector, and the third vector; and obtaining the local three by three matrix as a matrix having the first vector, the second vector, and the third vector as basis vectors.

In some implementations, transforming vertices of the GOC triangles based on corresponding difference transforms and updating vertex offsets and weights of the GOC triangles accordingly comprises, for vertices of the GOC triangles: finding original local offset (LO) vectors for the vertices of the GOC triangles by calculating differences of corresponding GOC vertex positions and corresponding GIC vertex positions; transforming the LO vectors by calculating products of local difference (LD) matrices for the corresponding GOC triangles, the original LO vectors, and areas of GIC triangles associated with the corresponding GOC triangles; adding the transformed LO vectors to vertex offsets for the vertices of the GOC triangles; and adding the areas of the GIC triangles to vertex weights for the vertices of the GOC triangles.

In some implementations, deforming the outer cage of the garment based on a deformed garment outer cage (GOC) position determined from iterating over the vertices of the outer cage of the garment comprises: finding, for vertices of the outer cage of the garment, final local offsets as previously summed vertex offsets divided by previously summed vertex weights; and deforming the outer cage of the garment based on the deformed GOC position of the outer cage of the garment determined based on vertices obtained as previous outer cage (POC) positions summed with the final local offsets.

According to another aspect, a non-transitory computer-readable medium is provided. The non-transitory computer-readable medium has instructions stored thereon that, responsive to execution by a processing device, causes the processing device to perform operations comprising: providing an avatar in a 3D virtual environment, the avatar having an avatar body to be layered with an inner garment and an outer garment; layering the inner garment onto the avatar body, wherein the layering includes: fitting the inner garment onto the avatar body; and deforming, using a linear cage deformer technique, an outer cage of the inner garment based on one or more of an outer cage of the avatar body and an inner cage of the inner garment; layering the outer garment onto the inner garment, wherein the layering includes: fitting the outer garment onto the inner garment based on the deformed outer cage of the inner garment and an inner cage of the outer garment; and deforming, using the linear cage deformer technique, an outer cage of the outer garment based on one or more of the deformed outer cage of the inner garment and the inner cage of the outer garment; and rendering the avatar body with the inner garment and the outer garment layered thereon.

Various implementations of the non-transitory computer-readable medium are described herein.

In some implementations, deforming the outer cage of the inner garment causes the outer garment to conform to a shape of the avatar body and a shape of the fitted inner garment.

In some implementations, the linear cage deformer technique comprises, to deform an outer cage of a garment based on an outer cage of a previous garment or avatar body portion: iterating over garment cage triangles of the garment and summing vertex offsets and weights of the garment cage triangles; and deforming the outer cage of the garment based on a deformed garment outer cage (GOC) position determined from iterating over vertices of the outer cage of the garment.

According to another aspect, a system is disclosed, comprising: a memory with instructions stored thereon; and a processing device, coupled to the memory, the processing device configured to access the memory, wherein the instructions when executed by the processing device cause the processing device to perform operations comprising: providing an avatar in a 3D virtual environment, the avatar having an avatar body to be layered with an inner garment and an outer garment; layering the inner garment onto the avatar body, wherein the layering includes: fitting the inner garment onto the avatar body; and deforming, using a linear cage deformer technique, an outer cage of the inner garment based on one or more of an outer cage of the avatar body and an inner cage of the inner garment; layering the outer garment onto the inner garment, wherein the layering includes: fitting the outer garment onto the inner garment based on the deformed outer cage of the inner garment and an inner cage of the outer garment; and deforming, using the linear cage deformer technique, an outer cage of the outer garment based on one or more of the deformed outer cage of the inner garment and the inner cage of the outer garment; and rendering the avatar body with the inner garment and the outer garment layered thereon.

Various implementations of the system are described herein.

In some implementations, deforming the outer cage of the inner garment causes the outer garment to conform to a shape of the avatar body and a shape of the fitted inner garment.

In some implementations, the linear cage deformer technique comprises, to deform an outer cage of a garment based on an outer cage of a previous garment or avatar body portion: iterating over garment cage triangles of the garment and summing vertex offsets and weights of the garment cage triangles; and deforming the outer cage of the garment based on a deformed garment outer cage (GOC) position determined from iterating over vertices of the outer cage of the garment.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram illustrating an example implementation of a linear cage deformer, in accordance with some implementations.

FIG. 2 is a diagram illustrating an example of an avatar with multiple layers of clothing, in accordance with some implementations.

FIG. 3 is a diagram illustrating an example of an avatar with multiple layers of clothing, in accordance with some implementations.

FIG. 4 is a diagram illustrating an example of an avatar with multiple layers of clothing, in accordance with some implementations.

FIG. 5A is a diagram illustrating an example of an avatar without clothing and with multiple layers of clothing, comparing existing radial basis function (RBF) techniques to techniques using linear cage deformer techniques, in accordance with some implementations.

FIG. 5B is another diagram illustrating an example of an avatar without clothing and with multiple layers of clothing, comparing existing radial basis function (RBF) techniques to techniques using linear cage deformer techniques, in accordance with some implementations.

FIG. 5C is another diagram illustrating an example of an avatar without clothing and with multiple layers of clothing, comparing existing radial basis function (RBF) techniques to techniques using linear cage deformer techniques, in accordance with some implementations.

FIG. 6 illustrates a flowchart of an example computer-implemented method to provide a three-dimensional (3D) avatar with multi-layered clothing in a 3D virtual environment, in accordance with some implementations.

FIG. 7 illustrates a flowchart of an example computer-implemented method to adjust a position of an outer cage vertex of an outer cage of an inner garment, in accordance with some implementations.

FIG. 8 illustrates a flowchart of an example computer-implemented method to adjust a position of an outer cage vertex of an outer cage of an outer garment, in accordance with some implementations.

FIG. 9 illustrates a flowchart of an example computer-implemented method to deform an outer cage of an inner garment, in accordance with some implementations.

FIG. 10 illustrates a flowchart of an example computer-implemented method to deform an outer cage of a garment, in accordance with some implementations.

FIG. 11 illustrates a flowchart of an example computer-implemented method to update vertex offsets and weights of garment outer cage (GOC) triangles, in accordance with some implementations.

FIG. 12 illustrates a flowchart of an example computer-implemented method to find difference transforms, in accordance with some implementations.

FIG. 13 illustrates a flowchart of an example computer-implemented method to obtain local matrices from vectors, in accordance with some implementations.

FIG. 14 illustrates a flowchart of an example computer-implemented method to update vertex offsets and vertex weights, in accordance with some implementations.

FIG. 15 is a diagram of an example system architecture that includes a 3D environment platform that can support 3D avatars with multi-layered clothing, in accordance with some implementations.

FIG. 16 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques of a linear cage deformer for improved fitting and rendering of multi-layered clothing accessories for three-dimensional (3D) avatars. The linear cage deformer reduces bulkiness of multi-layered clothing and generates more visually pleasing and realistic-looking dressed avatars. The deformer affects visuals of the avatar wearing two or more layers of clothing and retains the same appearances as when wearing single-layer clothing setups.

Existing layered clothing techniques use cage meshes to reshape garments to fit on arbitrarily shaped avatars. Such a layered clothing may apply layers of clothing using a radial basis function (RBF). The layered clothing system also supports multi-layered outfits. However, using RBF functions for multi-layered clothing presents problems. RBF uses interpolation and extrapolation, which may introduce distortions that lower image quality. Such distortions may be minor for a single layer of clothing, but as successive layers are fitted, using the RBF technique amplifies the distortions and causes substantial problems in rendering an avatar with multiple layers of clothing.

An avatar with multiple layers of clothing may have all of the cages (both inner and outer) for the multiple layers of clothing share a standardized UV layout. Accordingly, RBF may not be used to reshape garment outer cages. Instead, linear cage deformer techniques may find corresponding vertices of a garment inner cage and the previous layer outer cage (where the previous layer is an avatar body or the last garment fitted). Triangles that share these corresponding vertices may be used to find local coordinate frames for both cages. The position of the outer cage vertex of the current garment (i.e., the garment in a process of being layered) may then be adjusted and/or transformed using a difference between these new coordinate frames.

Adjusting vertices in outer cages of successive garments as set forth herein may have several potentially valuable properties. The provided techniques preserve the original spacing and alignment between the garment inner and outer cage for each garment when the new (i.e., adjusted) outer cage is generated. This improves the quality of the new outer cage. Additionally, because no extrapolation error is introduced, the artifacts are reduced as more layers are added.

The techniques permit any body geometry to be fitted with any clothing geometry, including enabling layers of clothing to be fitted over underlying layer(s) of clothing, thereby providing customization without the limits imposed by pre-defined geometries or using complex computations to make a clothing item compatible with arbitrary body shapes of avatars or other clothing items.

The multi-layered clothing fitting is also performed using a technique (i.e., algorithmically) such as a linear cage deformer technique by a gaming platform or gaming software (or other platform/software that operates to provide a 3D environment), without having avatar creators (avatar body creators, or body creators) or clothing item creators perform complex computations. The terms “clothing,” “clothing item,” or “clothing accessory” used herein are understood to include clothing and accessories, and any other item that can be placed on an avatar in relation to specific parts of an avatar body.

A linear cage deformer technique describes a space to apply to a clothing accessory or clothing item on an avatar when the multiple clothing items or accessories are layered on top of each other. For example, the techniques may be utilized to determine a first dataset that describes volume taken up by an unclothed body part of an avatar (e.g., a torso) and a second dataset that describes a volume taken up by a clothing item (e.g., a shirt) layered over the unclothed body part of the avatar.

The difference is computed between the first and the second datasets. The difference is then added to the second dataset when a subsequent layer of clothing is to be added on top of the first layer of clothing. When dealing with multi-layered clothing, the techniques iteratively apply a procedure involving calculating the differences between successive clothing layers and then accumulate these differences to create the final layered effect.

The techniques described herein for multi-layered clothing may be applied to avatars that are used in a virtual experience. Such virtual experiences are sometimes described herein in the context of an electronic game. The techniques described herein can be used for other types of virtual experiences in a three-dimensional (3D) environment that may not necessarily involve an electronic game having one or more players represented by avatars. Examples of virtual experiences may include a virtual reality (VR) conference, a 3D session (e.g., an online lecture or other type of presentation involving 3D avatars), an augmented reality (AR) session, or in other types of 3D environments in which one or more users are represented in the 3D environment by one or more 3D avatars.

For layered clothing, an automated cage-to-cage fitting technique may be used for 3D avatars. The techniques permit any body geometry to be fitted with any clothing geometry, including enabling layers of clothing to be fitted over underlying layer(s) of clothing, thereby providing customization without the limits imposed by pre-defined geometries, or using complex computations to make a clothing item compatible with arbitrary body shapes of avatars or other clothing items.

The cage-to-cage fitting techniques can also be performed on a gaming platform or gaming software (or other virtual experience platform/software that operates to provide a 3D environment) without having avatar creators (also referred to as avatar body creators, or body creators) or clothing item creators perform complex computations. The terms “clothing” or “piece of clothing” or other analogous terminology used herein are understood to include graphical representations of clothing and accessories, and any other item that can be placed on an avatar in relation to specific parts of an avatar cage.

At runtime during a virtual experience session, a player/user accesses a body library to select a particular avatar body and accesses a clothing library to select pieces of clothing to place on the selected body. A 3D environment platform that presents avatars implements the cage-to-cage fitting techniques to adjust (by suitable deformations, determined automatically) a piece of clothing to conform to the shape of the body, thereby automatically fitting the piece of clothing onto the avatar body (and any intermediate layers, if worn by the avatar).

When the piece of clothing is fitted over the avatar body and/or underlying piece of clothing on the avatar body, the techniques described herein may be performed to deform or otherwise fit the piece of clothing more precisely to the avatar, such as in terms of scale (e.g., proportionality), shape, etc. The user can further select an additional piece of clothing to fit over an underlying piece of clothing, with the additional piece of clothing being deformed to match the geometry of the underlying piece of clothing.

The implementations described herein are based on the concept of “cages” and “meshes.” A body “mesh” (or “render mesh”) is the actual visible geometry of an avatar. A body “mesh” includes graphical representations of body parts such as arms, legs, torso, head parts, etc. and can be of arbitrary shape, size, and geometric topology. Analogously, a clothing “mesh” (or “render mesh”) can be any arbitrary mesh that graphically represents a piece of clothing, such as a shirt, pants, hat, shoes, etc. or parts thereof.

In comparison, a “cage” represents an envelope of features points around the avatar body that is simpler than the body mesh and has weak correspondence to the corresponding vertices of the body mesh. As is explained in further detail later below, a cage may also be used to represent not only the set of feature points on an avatar body, but also a set of feature points on a piece of clothing.

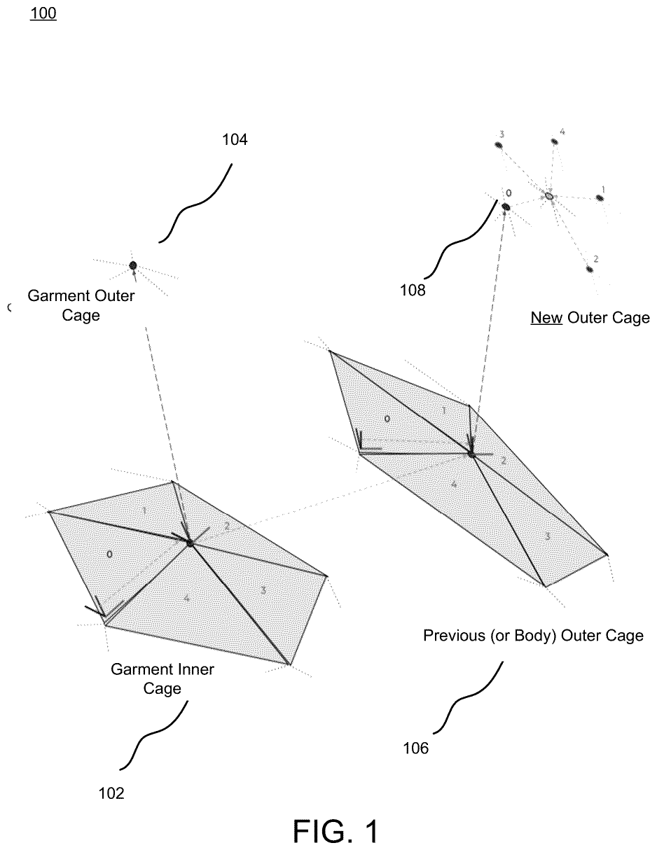

### FIG. 1—Linear Cage Deformer

FIG. 1 is a diagram illustrating an example implementation 100 of a linear cage deformer, in accordance with some implementations. FIG. 1 shows a garment inner cage 102 and an associated garment outer cage 104. Garment inner cage 102 may be associated with a previous (or body) outer cage 106. For example, if a garment being fit is an innermost garment, previous (or body) outer cage 106 is that of an avatar body itself. If a garment being fit is a garment fit on top of one or more inner garments, previous (or body) outer cage 106 is that of the garment immediately preceding the current garment.

Such a previous (or body) outer cage 106 may be used in correspondence with garment inner cage 102 to construct a new (i.e., updated and/or adjusted) outer cage 108 for the current garment based on the original associated garment outer cage 104. The new outer cage 108 may preserve certain properties of the garment inner cage 102 and the garment outer cage 104.

In greater detail, the following techniques may be applied to improve the layering of clothing. The techniques may include iterating over garment cage triangles and sum vertex offsets and weights. Such iterating may include computing, for all or some of the triangles, a difference transform from a previous outer cage (POC) triangle to a garment inner cage (GIC) triangle.

Finding the difference transform may also include computing local three by three matrices for the POC and the GIC triangles. For example, when computing local three by three matrices corresponding to the POC and GIC triangles, vectors u and v may be two triangle edges for each triangle. A vector w may be found as a cross product of vectors u and v. Then, u, v, and w are normalized. The local matrix (for a POC or GIC triangle) may then be obtained by using u, v, and w as basis vectors of a given triangle.

The difference transforms obtain a local difference (LD) as a three by three matrix as a POC matrix multiplied by an inverse of the GIC matrix. To finish computing the difference transform, a transform is applied to the three original corners of an original garment outer cage (GOC) triangle. A local offset vector (LO) is found as a GOC vertex position minus a GIC vertex position. Then, the LO vector is transformed to be a product of the LD matrix, the LO vector, and the GIC triangle area. During the iteration, the transformed LO is added to a vertex offset and a GIC triangle area is added to a vertex weight.

After the iteration over the garment cage triangles, there may be another iteration over vertices of the garment outer cage to compute a final GOC position. For example, for such vertices, final local offsets are found as previously summed vertex offsets (from the iteration) divided by vertex weights (from the iteration). The final position of vertices in the final GOC is found as POC positions plus the final local offsets.

The techniques set forth herein preserve an original spacing and alignment between the garment inner and outer cages when the new outer cage is generated. This improves the quality of the new outer cage, because no extrapolation error is introduced, and the artifacts do not compound as more layers are added.

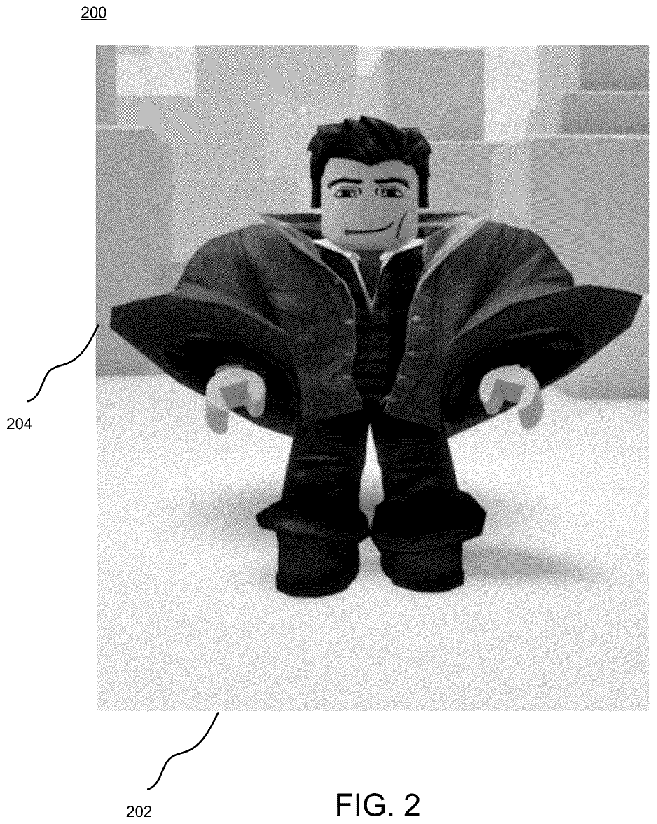

### FIG. 2—Example Avatar

FIG. 2 is a diagram illustrating an example 200 of an avatar 202 with multiple layers of clothing, in accordance with some implementations. The flared cuffs 204 are a compounded extrapolation artifact. Such an extrapolation artifact may occur due to the use of a radial basis function (RBF) technique when layering multiple layers of clothing. Such flared cuffs 204 adversely affect the visual quality of avatar 202.

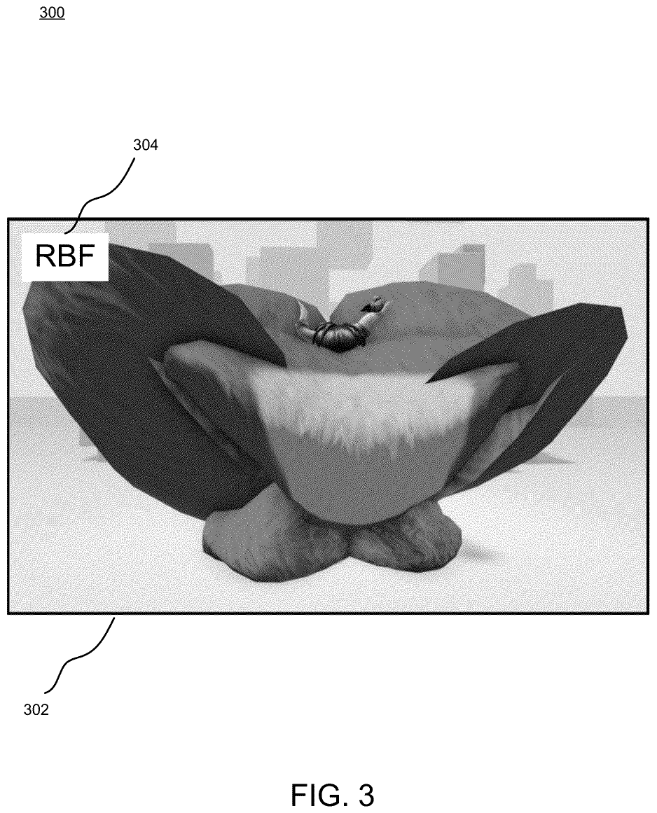

### FIG. 3—Example Avatar

FIG. 3 is a diagram illustrating an example 300 of an avatar 302 with multiple layers of clothing, in accordance with some implementations. The outfit is larger than expected and distorted due to compounding extrapolations. FIG. 3 indicates that avatar 302 is generated with an RBF technique 304. Such distortions adversely affect the visual quality of avatar 302.

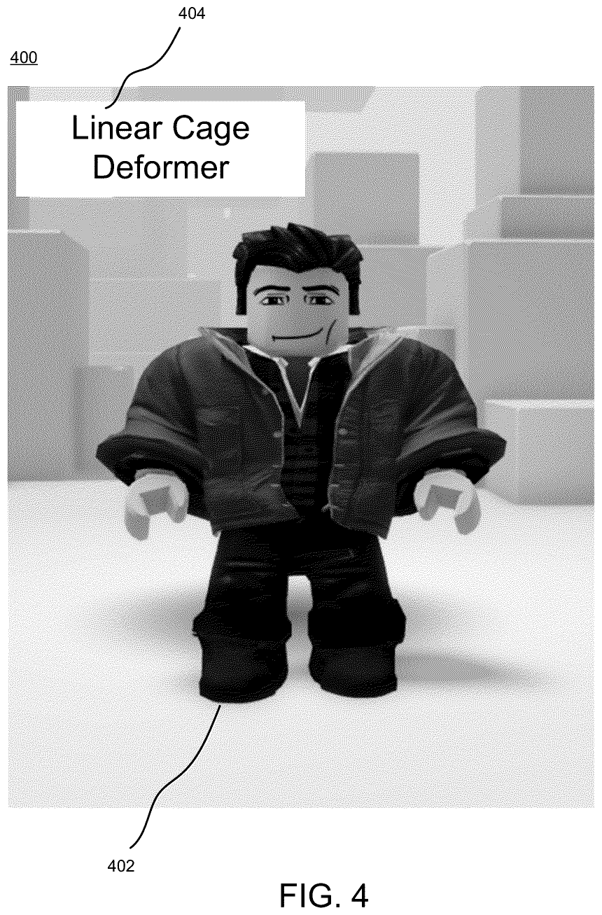

### FIG. 4—Example Avatar

FIG. 4 is a diagram illustrating an example 400 of an avatar 402 with multiple layers of clothing, in accordance with some implementations. The outfit is computed using the linear cage deformer, in accordance with some implementations. FIG. 4 indicates that avatar 402 is generated with a linear cage deformer 404. FIG. 4 illustrates that avatar 402 has clothes with a far more natural fit than those of avatar 202 (as illustrated in FIG. 2), despite there being multiple layers of clothes.

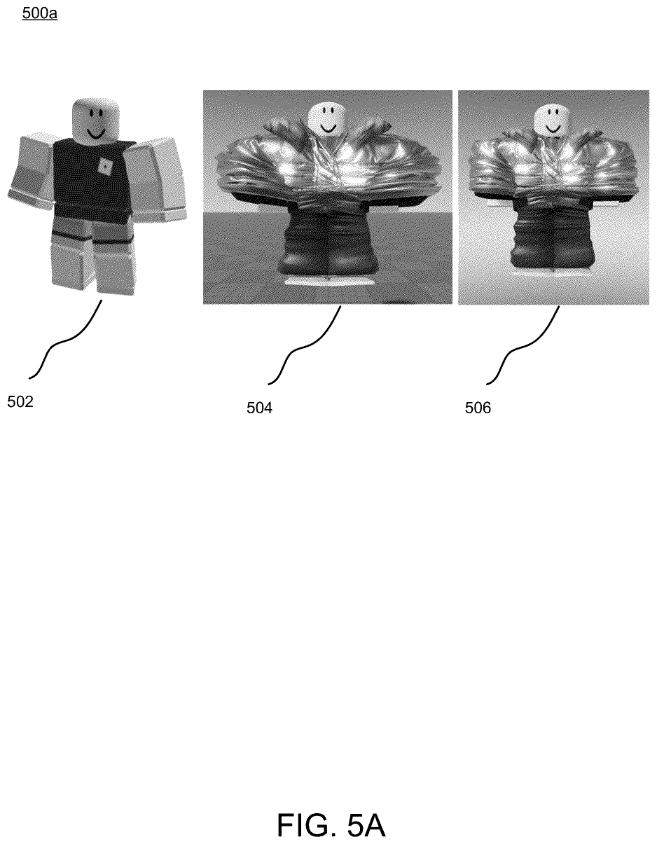

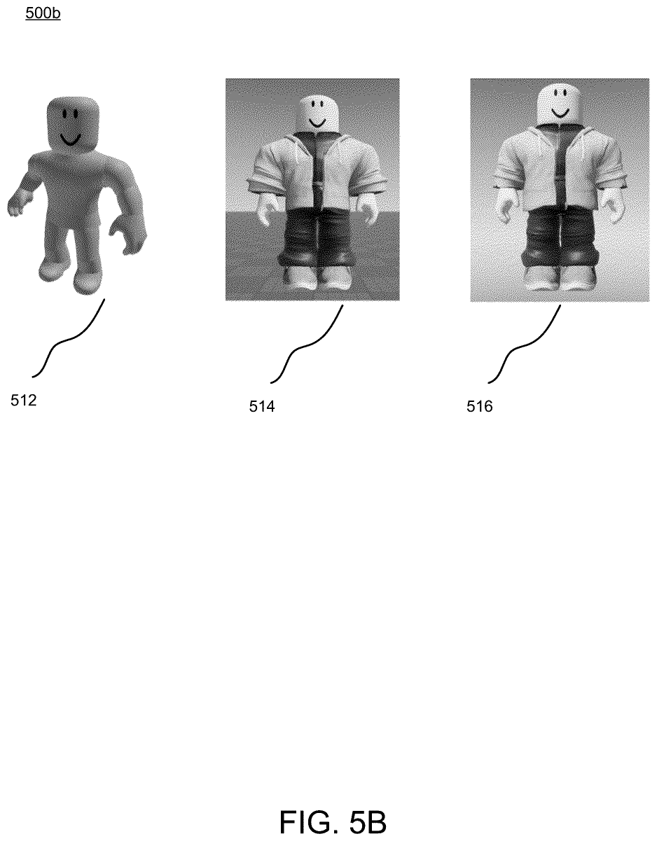

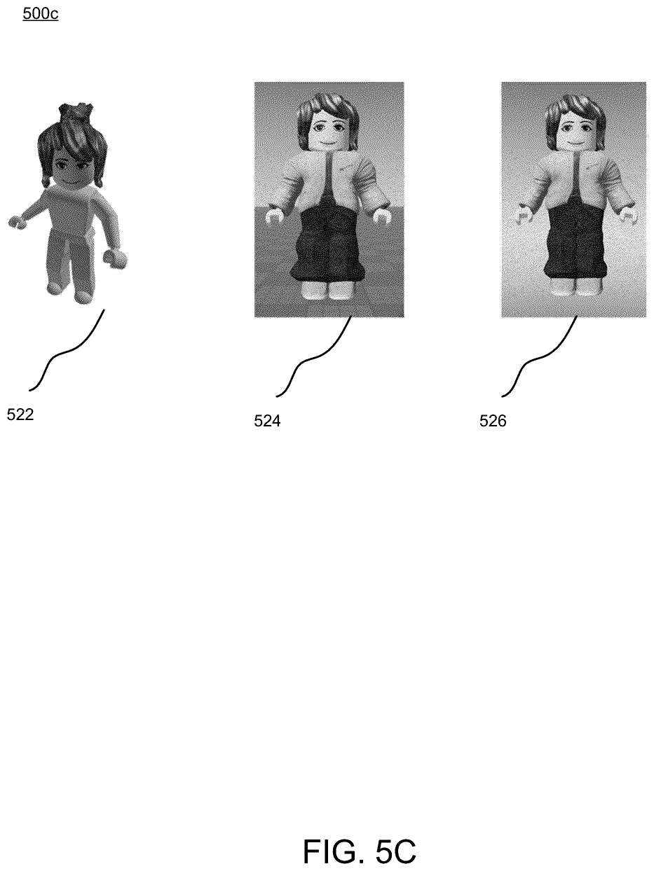

### FIG. 5A—Example Avatar With and Without Clothing

FIG. 5A is a diagram illustrating an example 500a of an avatar without clothing and with multiple layers of clothing, comparing existing radial basis function (RBF) techniques to techniques using linear cage deformer techniques, in accordance with some implementations.

For example, avatar 502 may be a default avatar. Using existing clothing layering techniques (such as RBF) may result in avatar 504 having a multi-layered clothing fit that is bulky and inflates the layers as they are placed over each other. However, avatar 506 may use techniques described herein (such as a linear cage deformer) to provide updated fitting using multi-layered techniques presented herein to make avatar 506 look more natural and visually appealing.

### FIG. 5B—Example Avatar With and Without Clothing

FIG. 5B is another diagram illustrating an example 500b of an avatar without clothing and with multiple layers of clothing, comparing existing radial basis function (RBF) techniques to techniques using linear cage deformer techniques, in accordance with some implementations.

For example, avatar 512 may be a boy avatar. Avatar 514 generated using existing techniques (such as RBF) may result in an air gap between the sleeve and the arm. Avatar 516 generated using techniques described herein (such as a linear cage deformer) provides a new look with sleeves retaining proportions while properly fitting the arms.

### FIG. 5C—Example Avatar With and Without Clothing

FIG. 5C is another diagram illustrating an example 500c of an avatar without clothing and with multiple layers of clothing, comparing existing radial basis function (RBF) techniques to techniques using linear cage deformer techniques, in accordance with some implementations.

For example, avatar 522 may be a woman avatar. Avatar 524 generated using existing techniques (such as RBF) may result in an overly puffy jacket. Avatar 526 generated using techniques described herein (such as a linear cage deformer) provides a new look with a more realistic fit. For example, FIG. 5C also shows that avatar 524 and avatar 526 may differ from avatar 522 in other ways, such as by having hair fit thereon.

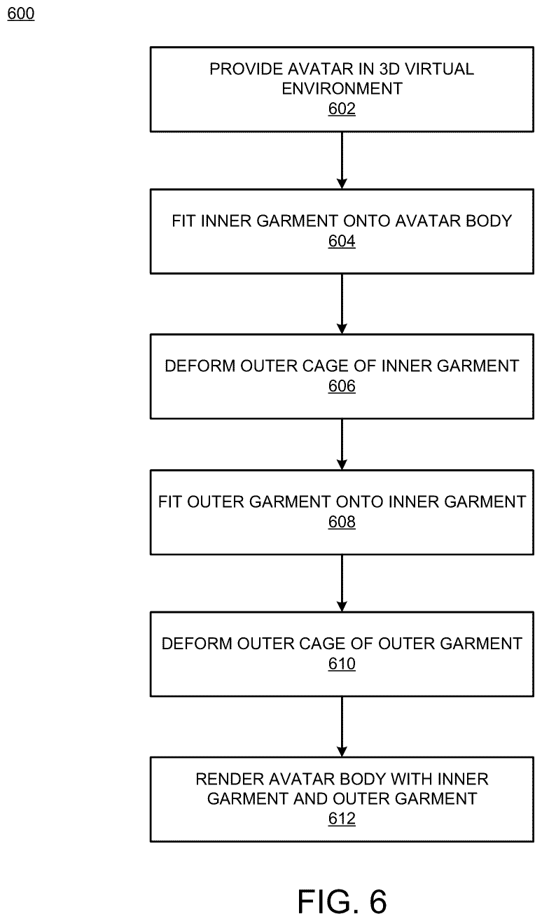

### FIG. 6—Providing 3D Avatar With Multi-Layered Clothing

FIG. 6 illustrates a flowchart of an example computer-implemented method 600 to provide a three-dimensional (3D) avatar with multi-layered clothing in a 3D virtual environment, in accordance with some implementations. Method 600 may begin at block 602.

At block 602, an avatar may be provided in a 3D virtual environment. For example, the avatar may be selected from an avatar repository. the avatar may have an avatar body to be layered with an inner garment and, optionally, one or more outer garments. The avatar may be provided in various ways. Block 602 may be followed by block 604. At block 604 and block 606, an inner garment is layered onto the avatar body.

At block 604, an inner garment is fitted onto the avatar body. For example, such fitting may involve establishing a correspondence between an outer cage of the avatar body and an inner cage of the inner garment and using this correspondence to fit the inner garment onto the avatar body. The inner garment, depending on its type, may be fitted onto one or more portions of the avatar body. For example, a t-shirt may be fitted onto a torso and upper arms of the avatar body. Block 604 may be followed by block 606.

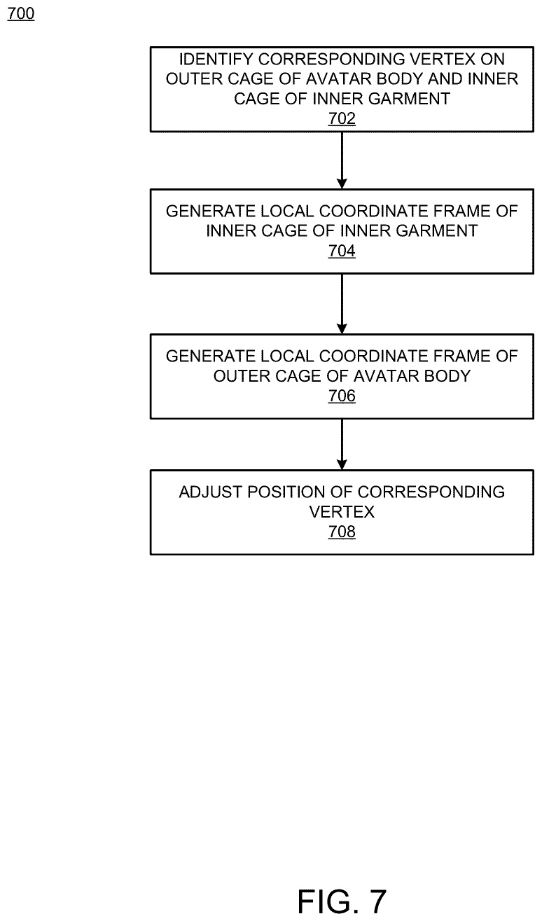

At block 606, an outer cage of the inner garment is deformed. For example, the deforming may use a linear cage deformer technique based on an outer cage of the avatar body and/or an inner cage of the inner garment. Additional details of how block 606 may be performed are illustrated at FIG. 7. Block 606 may be followed by block 608.

However, in some implementations, only a single (inner) garment is fit onto the avatar body and deformed. Thus, in some implementations, block 608 and block 610 are omitted, and the avatar body may be rendered with only the inner garment. However, when multiple garments are placed on an avatar body, block 606 is often followed by block 608.

At block 608 and block 610, an outer garment is layered onto the inner garment.

At block 608, an outer garment is fitted onto an inner garment. For example, such fitting may involve establishing a correspondence between an outer cage of the inner garment and an inner cage of the outer garment and using this correspondence to fit the outer garment onto the inner garment.

The outer garment, depending on its type, may be fitted onto one or more inner garments layered onto portions of the avatar body. For example, a vest may be fitted onto a dress shirt previously layered onto a torso of the avatar body (but not necessarily arms of the avatar body). Block 608 may be followed by block 610.

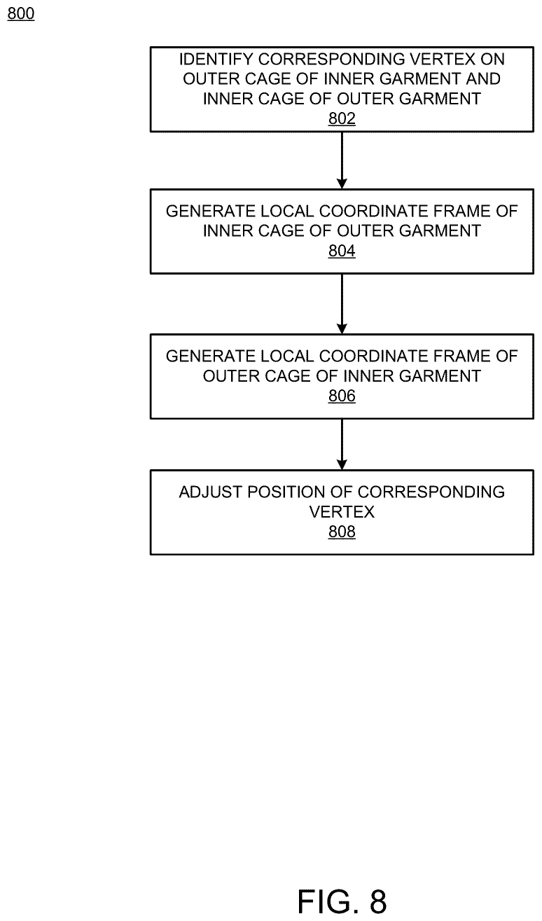

At block 610, an outer cage of the outer garment is deformed. For example, the deforming may use a linear cage deformer technique based on the deformed outer cage of the inner garment and/or an inner cage of the outer garment. Additional details of how block 610 may be performed are illustrated at FIG. 8. Such deforming improves the fit of the outer garment onto the avatar body and the inner garment and also aids in fitting subsequent garments onto the avatar body. Block 610 may be followed by block 612 for rendering.

However, in some implementations, there may be more than two layers of garments. In such implementations, after fitting the outer garment onto the inner garment at block 608 and deforming the outer cage of outer garment at block 610, other garments may be layered onto the existing garments sequentially. Such layering includes fitting a next garment onto an immediately previous garment and deforming the next garment's outer cage to render and/or fit a next garment.

At block 612, the avatar body may be rendered with the inner garment and the outer garment. If there are two or more garments, at block 612, the avatar body may be rendered with all or some of the layered garments.

### FIG. 7—Adjusting Outer Cage Vertex of Outer Cage of Inner Garment

FIG. 7 illustrates a flowchart of an example computer-implemented method 700 to adjust a position of an outer cage vertex of an outer cage of an inner garment, in accordance with some implementations. Method 700 may begin at block 702.

At block 702, a corresponding vertex on an outer cage of an avatar body and an inner cage of an inner garment is identified. For example, such a corresponding vertex is identified based on finding a relationship based on where the outer cage of the avatar body the inner cage of the inner garment is to fit. Such a corresponding vertex may serve as the basis of deforming the outer cage of the inner garment. Block 702 may be followed by block 704.

At block 704, a local coordinate frame of the inner cage of the inner garment is generated. For example, the local coordinate frame of the inner cage of the inner garment may be generated based on triangles that share the identified vertex. Block 704 may be followed by block 706.

At block 706, a local coordinate frame of the outer cage of the avatar body is generated. For example, the local coordinate frame of the outer cage of the avatar body may be generated based on triangles that share the identified vertex. Block 706 may be followed by block 708.

At block 708, a position of a corresponding vertex is adjusted. For example, the adjustment may be based on a difference between the local coordinate frame of the inner cage of the inner cage of the inner garment and the local coordinate frame of the outer cage of the avatar body. By using this difference, it may be possible to preserve the original spacing and alignment between the inner garment inner and outer cages when generating the new outer cage for the inner garment.

### FIG. 8—Adjusting Outer Cage Vertex of Outer Cage of Outer Garment

FIG. 8 illustrates a flowchart of an example computer-implemented method 800 to adjust a position of an outer cage vertex of an outer cage of an outer garment, in accordance with some implementations. Method 800 may begin at block 802.

At block 802, a corresponding vertex on an outer cage of an inner garment and an inner cage of an outer garment is identified. For example, such a corresponding vertex is identified based on finding a relationship based on where on the outer cage of the inner garment the inner cage of the outer garment is to fit. Such a corresponding vertex may serve as the basis of deforming the outer cage of the outer garment. Block 802 may be followed by block 804.

At block 804, a local coordinate frame of the inner cage of the outer garment is generated. For example, the local coordinate frame of the inner cage of the outer garment may be generated based on triangles that share the identified vertex. Block 804 may be followed by block 806.

At block 806, a local coordinate frame of the outer cage of the inner garment is generated. For example, the local coordinate frame of the outer cage of the inner garment may be generated based on triangles that share the identified vertex. Block 806 may be followed by block 808.

At block 808, a position of a corresponding vertex is adjusted. For example, the adjustment may be based on a difference between the local coordinate frame of the inner cage of the outer garment and the local coordinate frame of the outer cage of the inner garment. By using this difference, it may be possible to preserve the original spacing and alignment between the outer garment inner and outer cages when generating the new outer cage for the outer garment.

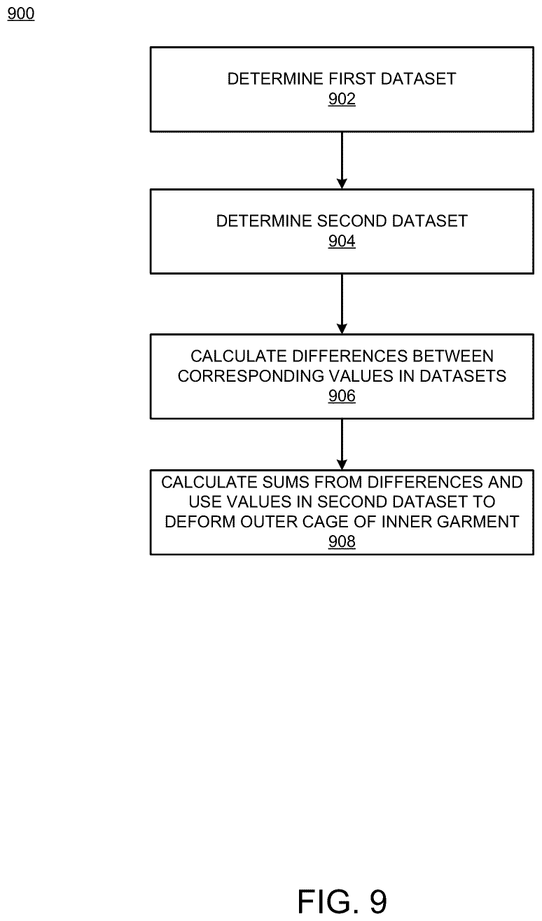

### FIG. 9—Deforming Outer Cage of Inner Garment

FIG. 9 illustrates a flowchart of an example computer-implemented method 900 to deform an outer cage of an inner garment, in accordance with some implementations. Method 900 may begin at block 902.

At block 902, a first dataset is determined (i.e., first dataset values are determined). Such a first dataset may describe a volume taken up by an unclothed body part of an avatar (e.g., a torso). The first dataset may help identify a relationship between the avatar and the clothing layered thereon. Block 902 may be followed by block 904.

At block 904, a second dataset is determined (i.e., second dataset values are determined). Such a second dataset may describe a volume taken up by a clothing item (e.g., a shirt) layered over the unclothed body part of the avatar. The second dataset may also help identify a relationship between the avatar and the clothing layered thereon. Block 904 may be followed by block 906.

At block 906, differences between corresponding values in the first dataset and the values in the second dataset are calculated. Thus, each difference may indicate a discrepancy between a vertex in the first dataset (which corresponds to the avatar body) and a vertex in the second dataset (which corresponds to the clothing item). Block 906 may be followed by block 908.

At block 908, sums from the calculated differences and values in the second dataset are calculated to deform the outer cage of the inner garment. Such sums preserve spacing and alignment between garment inner and outer cages when generating an adjusted outer cage for the garment.

While FIG. 9 pertains to an example in which volume datasets are identified and used for an avatar body and an initial piece of clothing, similar operations may be used to establish volumes for a piece of layered clothing and a subsequent piece of layered clothing, and differences of these volumes can be summed with values from datasets to deform outer cages of successive layers of clothing.

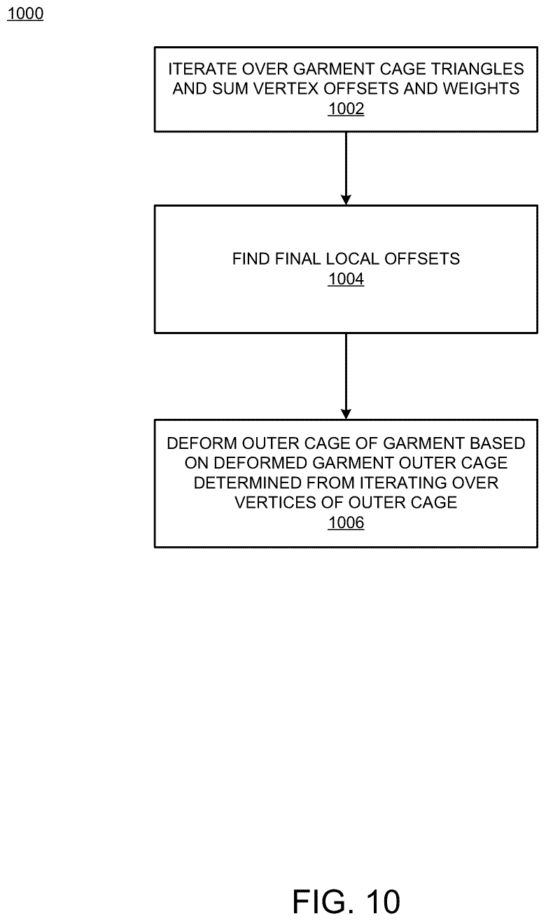

### FIG. 10—Deforming Outer Cage of Garment

FIG. 10 illustrates a flowchart of an example computer-implemented method 1000 to deform an outer cage of a garment, in accordance with some implementations. Method 1000 may begin at block 1002.

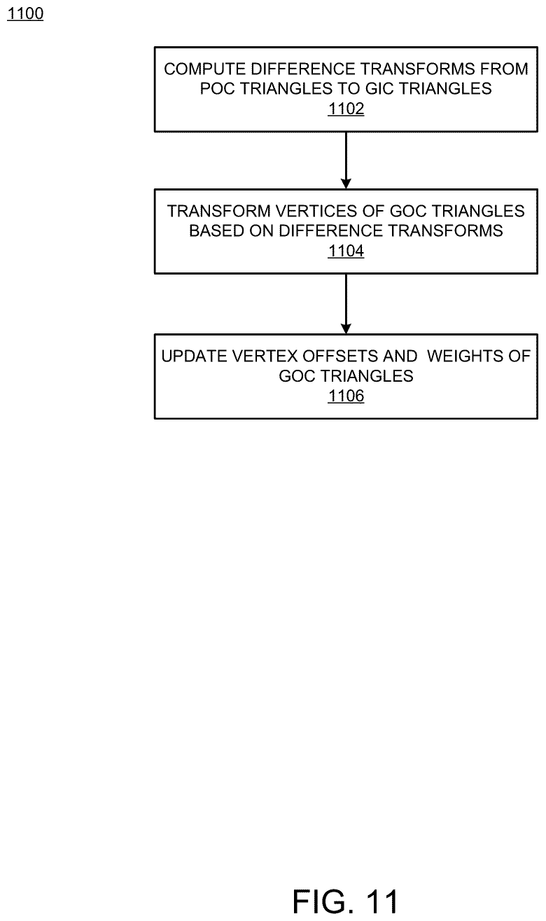

At block 1002, garment cage triangles are iterated over while summing vertex offsets and weights. Additional details of such an iteration with respect to triangles are presented in FIG. 11. Such iteration gathers information about relationships between previous outer cage (POC) triangles and garment inner cage (GIC) triangles and what transformations may be appropriate for garment outer cage (GOC) triangles. Block 1002 may be followed by block 1004.

At block 1004, final local offsets are found. Such final local offsets may be found by taking a previously summed vertex offset for each vertex (as found in block 1002) and dividing the summed vertex offset by a corresponding vertex weight (also as found in block 1002). Because block 1002 iterates over the garment triangles, after the iterating, the summed vertex offset and the vertex weight reflect how to transform GOC vertices into vertices for a deformed garment outer cage used for updating an outer cage of the garment. Block 1004 may be followed by block 1006.

At block 1006, an outer cage of the garment may be deformed based on a deformed garment outer cage determined from iterating over vertices of the outer cage. For example, the vertices in the outer cage of the garment may be adjusted to have a final position that is found from the corresponding POC vertices plus the final local offsets calculated at block 1004.

Using such final offsets provides for new vertex positions for vertices of the outer cage with the technical advantages discussed above (e.g., preserving original spacing and alignment without introducing extrapolation error, thus improving quality and avoiding compounded artifacts).

### FIG. 11—Updating Vertex Offsets and Weights of Garment Outer Cage (GOC) Triangles

FIG. 11 illustrates a flowchart of an example computer-implemented method 1100 to update vertex offsets and weights of garment outer cage (GOC) triangles, in accordance with some implementations. Method 1100 may begin at block 1102.

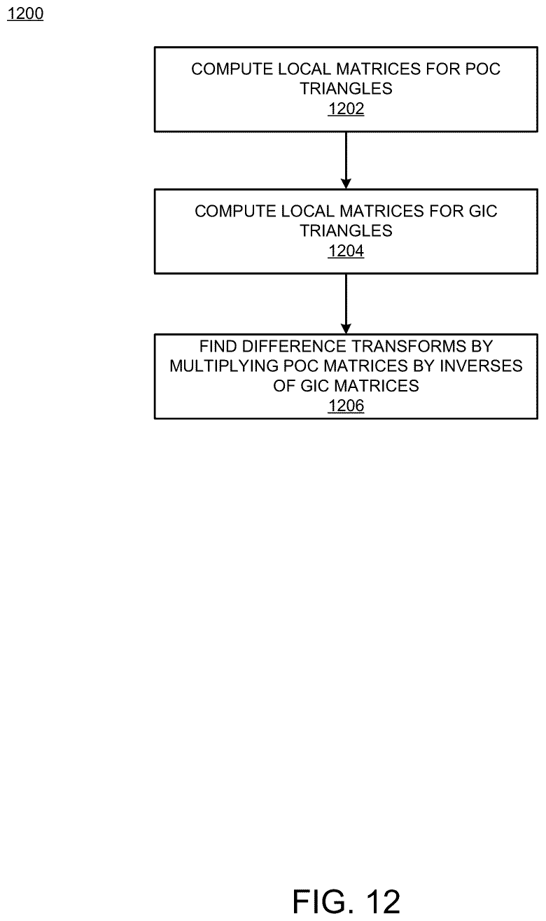

At block 1102, difference transforms from POC triangles to GIC triangles may be computed. The difference transforms may be found by computing local matrices and finding a product based on the matrices. Additional details of block 1102 are presented in FIG. 12. Block 1102 may be followed by block 1104.

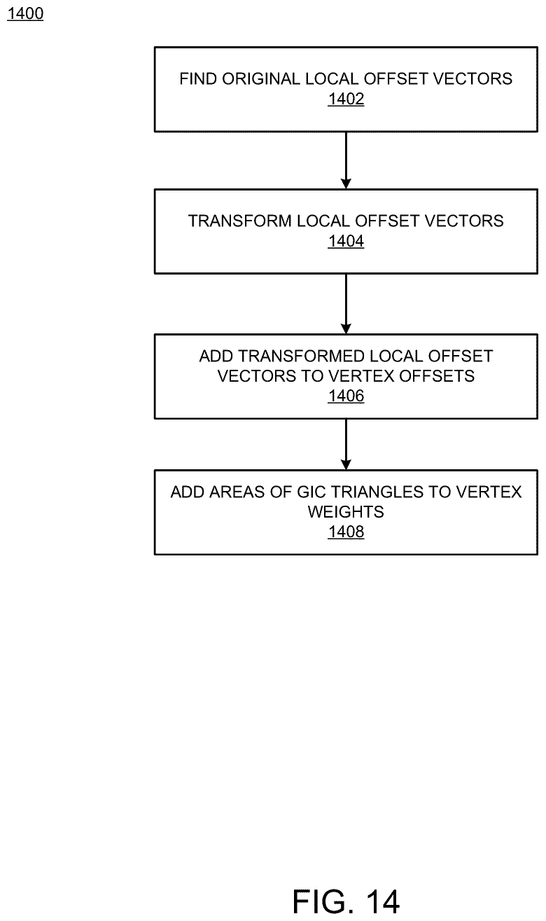

At block 1104, vertices of GOC triangles are transformed based on the difference transforms. There may be local offset vectors, which are modified prior to use in a transformation. Additional details of block 1104 are presented in FIG. 14. Block 1104 may be followed by block 1106.

At block 1106, vertex offsets and weights of GOC triangles are updated. Vertex offsets may be updated based on local offsets and vertex weights may be updated based on triangle areas. Additional details of block 1106 are presented in FIG. 14. After block 1106, the iterating of block 1002 may be complete and method 1000 of FIG. 10 may continue with finding final local offsets at block 1004.

### FIG. 12—Finding Difference Transforms

FIG. 12 illustrates a flowchart of an example computer-implemented method 1200 to find difference transforms, in accordance with some implementations. Method 1200 may begin at block 1202.

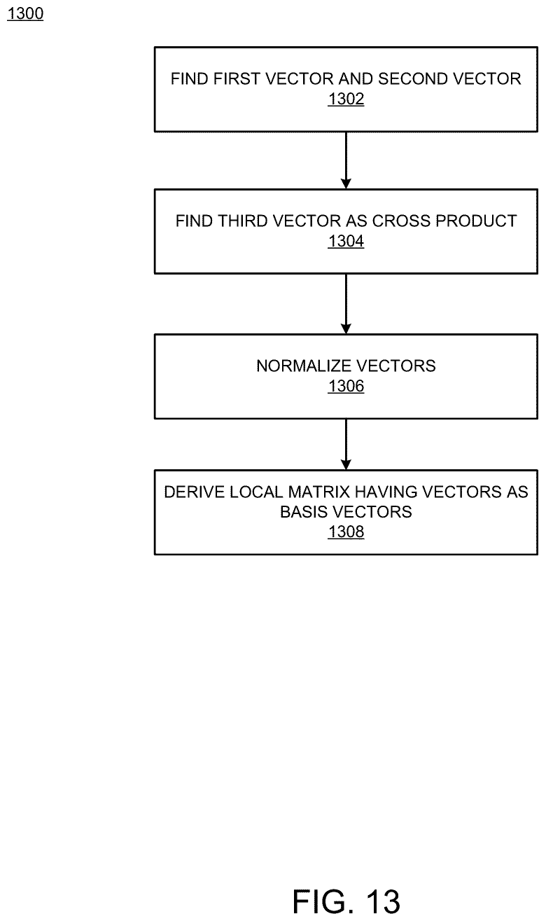

At block 1202, local matrices for POC triangles are computed by using vectors corresponding to the triangles. Details of block 1202 are presented in FIG. 13 (with respect to how to obtain a local matrix as used herein for a given triangle). Block 1202 may be followed by block 1204.

At block 1204, local matrices for GIC triangles are computed by using vectors corresponding to the triangles. Details of block 1204 are presented in FIG. 13 (with respect to how to obtain a local matrix as used herein for a given triangle). Block 1204 may be followed by block 1206.

At block 1206, difference transforms may be found by multiplying the local metrices for the POC triangles by inverses of the local matrices for the GIC triangles. The result of this multiplying is a three by three matrix that can be used for difference transforms.

### FIG. 13—Obtaining Local Matrices From Vectors

FIG. 13 illustrates a flowchart of an example computer-implemented method 1300 to obtain local matrices from vectors, in accordance with some implementations. Method 1300 may begin at block 1302.

At block 1302, a first vector and a second vector may be found. For example, the first vector and the second vector may define a triangle, such as for a POC triangle or a GIC triangle whose local matrix is being obtained. The first vector and the second vector may be edges of the current triangle. For example, the first vector may be referred to as u, and the second vector may be referred to as v.

At block 1304, a third vector may be found as a cross product (or vector product) of u and v. Such a third vector may be referred to as a vector w.

At block 1306, the three vectors (u, v, and w) are normalized. That is, each vector retains its direction while being transformed into a unit vector (i.e., the length of the vector is one linear unit).

At block 1308, a local matrix having the vectors as basis vectors is obtained. Such a matrix may be obtained using linear algebra techniques to identify the local matrix.

### FIG. 14—Updating Vertex Offsets and Vertex Weights

FIG. 14 illustrates a flowchart of an example computer-implemented method 1400 to update vertex offsets and vertex weights, in accordance with some implementations. Method 1400 may begin at block 1402.

At block 1402, original local offset vectors are found. For example, a local offset (LO) vector may be found as a GOC vertex position minus a GIC vertex position. Hence, an original LO vector may represent an original offset between an outer cage vertex of a garment and an inner cage vertex of a garment. Block 1402 may be followed by block 1404.

At block 1404, the original local offset vectors are transformed. Such a transformation is based on finding a product of the LD matrix (found as illustrated in FIGS. 12 and 13) multiplied by the original LO matrix multiplied by a GIC triangle area (such an area may be found using vector products based on vectors defining edges of a triangle). Block 1404 may be followed by block 1406.

At block 1406, the transformed local offset vectors are added to vertex offsets (as a running sum). Block 1406 may be followed by block 1408.

At block 1408, the areas of GIC triangles are added to vertex weights (as a running sum).

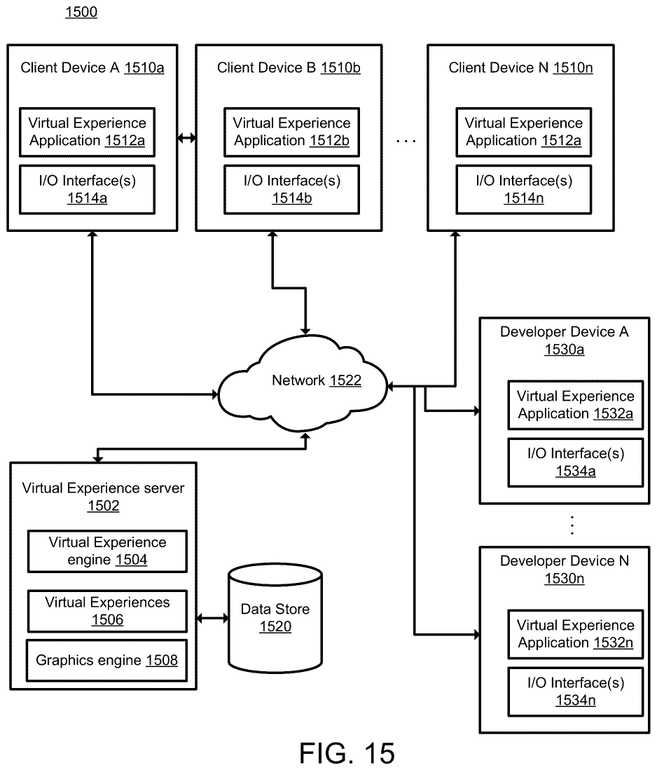

### FIG. 15—System Architecture

FIG. 15 is a diagram of an example system architecture that includes a 3D environment platform that can support 3D avatars with multi-layered clothing, in accordance with some implementations. FIG. 15 and the other figures use like reference numerals to identify similar elements. A letter after a reference numeral, such as “1510,” indicates that the text refers specifically to the element having that particular reference numeral. A reference numeral in the text without a following letter, such as “1510,” refers to any or all of the elements in the figures bearing that reference numeral (e.g., “1510” in the text refers to reference numerals “1510a,” “1510b,” and/or “1510n” in the figures).

The system architecture 1500 (also referred to as “system” herein) includes online virtual experience server 1502, data store 1520, client devices 1510a, 1510b, and 1510n (generally referred to as “client device(s) 1510” herein), and developer devices 1530a and 1530n (generally referred to as “developer device(s) 1530” herein). Virtual experience server 1502, data store 1520, client devices 1510, and developer devices 1530 are coupled via network 1522. In some implementations, client devices(s) 1510 and developer device(s) 1530 may refer to the same or same type of device.

Online virtual experience server 1502 can include, among other things, a virtual experience engine 1504, one or more virtual experiences 1506, and graphics engine 1508. In some implementations, the graphics engine 1508 may be a system, application, or module that permits the online virtual experience server 1502 to provide graphics and animation capability. In some implementations, the graphics engine 1508 and/or virtual experience engine 1504 may perform one or more of the operations described below in connection with the flowcharts shown in FIGS. 7-14. A client device 1510 can include a virtual experience application 1512, and input/output (I/O) interfaces 1514 (e.g., input/output devices). The input/output devices can include one or more of a microphone, speakers, headphones, display device, mouse, keyboard, game controller, touchscreen, virtual reality consoles, etc.

A developer device 1530 can include a virtual experience application 1532, and input/output (I/O) interfaces 1534 (e.g., input/output devices). The input/output devices can include one or more of a microphone, speakers, headphones, display device, mouse, keyboard, game controller, touchscreen, virtual reality consoles, etc.

System architecture 1500 is provided for illustration. In different implementations, the system architecture 1500 may include the same, fewer, more, or different elements configured in the same or different manner as that shown in FIG. 15.

In some implementations, network 1522 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 1520 may be a non-transitory computer readable memory (e.g., random access memory), a cache, a drive (e.g., a hard drive), a flash drive, a database system, or another type of component or device capable of storing data. The data store 1520 may also include multiple storage components (e.g., multiple drives or multiple databases) that may also span multiple computing devices (e.g., multiple server computers). In some implementations, data store 1520 may include cloud-based storage.

In some implementations, the online virtual experience server 1502 can include a server having one or more computing devices (e.g., a cloud computing system, a rackmount server, a server computer, cluster of physical servers, etc.). In some implementations, the online virtual experience server 1502 may be an independent system, may include multiple servers, or be part of another system or server.

In some implementations, the online virtual experience server 1502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 1502 and to provide a user with access to online virtual experience server 1502. The online virtual experience server 1502 may also include a website (e.g., a web page) or application back-end software that may be used to provide a user with access to content provided by online virtual experience server 1502. For example, users may access online virtual experience server 1502 using the virtual experience application 1512 on client devices 1510.

In some implementations, virtual experience session data are generated via online virtual experience server 1502, virtual experience application 1512, and/or virtual experience application 1532, and are stored in data store 1520. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 1502 may be a type of social network providing connections between users or a type of user-generated content system that allows users (e.g., end-users or consumers) to communicate with other users on the online virtual experience server 1502, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 1520 or within virtual experiences 1506. The data store 1520 may be utilized to store chat transcripts (text, audio, images, etc.) exchanged between participants, with appropriate permissions from the players and in compliance with applicable regulations.

In some implementations, the chat transcripts are generated via virtual experience application 1512 and/or virtual experience application 1532 or and are stored in data store 1520. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 1520.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 1502 may be a virtual gaming server. For example, the gaming server may provide single-player or multiplayer games to a community of users that may access as “system” herein) includes online virtual experience server 1502, data store 1520, client or interact with virtual experiences using client devices 1510 via network 1522. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 1510) within a virtual experience (e.g., 1506) or the presentation of the interaction on a display or other output device (e.g., 1514) of a client device 1510. For example, virtual experience engagement may include interactions with one or more participants within a virtual experience or the presentation of the interactions on a display of a client device.

In some implementations, a virtual experience 1506 can include an electronic file that can be executed or loaded using software, firmware or hardware configured to present the virtual experience content (e.g., digital media item) to an entity. In some implementations, a virtual experience application 1512 may be executed and a virtual experience 1506 rendered in connection with a virtual experience engine 1504. In some implementations, a virtual experience 1506 may have a common set of rules or common goal, and the environment of a virtual experience 1506 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 1506 may be collectively referred to as a “world” or “virtual experience world” or “gaming world” or “virtual world” or “universe” herein. An example of a world may be a 3D world of a virtual experience 1506. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 1502 can host one or more virtual experiences 1506 and can permit users to interact with the virtual experiences 1506 using a virtual experience application 1512 of client devices 1510. Users of the online virtual experience server 1502 may play, create, interact with, or build virtual experiences 1506, communicate with other users, and/or create and build objects (e.g., also referred to as “item(s)” or “virtual experience objects” or “virtual experience item(s)” herein) of virtual experiences 1506.

For example, in generating user-generated virtual items, users may create characters, decoration for the characters, one or more virtual environments for an interactive virtual experience, or build structures used in a virtual experience 1506, among others. In some implementations, users may buy, sell, or trade virtual experience objects, such as in-platform currency (e.g., virtual currency), with other users of the online virtual experience server 1502. In some implementations, online virtual experience server 1502 may transmit virtual experience content to virtual experience applications (e.g., 1512). In some implementations, virtual experience content (also referred to as “content” herein) may refer to any data or software instructions (e.g., virtual experience objects, virtual experience, user information, video, images, commands, media item, etc.) associated with online virtual experience server 1502 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 1506 of the online virtual experience server 1502 or virtual experience applications 1512 of the client devices 1510. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 1502 hosting virtual experiences 1506, is provided for purposes of illustration. In some implementations, online virtual experience server 1502 may host one or more media items that can include communication messages from one user to one or more other users. With user permission and express user consent, the online virtual experience server 1502 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 1506 may be associated with a particular user or a particular group of users (e.g., a private virtual experience), or made widely available to users with access to the online virtual experience server 1502 (e.g., a public virtual experience). In some implementations, where online virtual experience server 1502 associates one or more virtual experiences 1506 with a specific user or group of users, online virtual experience server 1502 may associate the specific user(s) with a virtual experience 1506 using user account information (e.g., a user account identifier such as username and password).

In some implementations, online virtual experience server 1502 or client devices 1510 may include a virtual experience engine 1504 or virtual experience application 1512. In some implementations, virtual experience engine 1504 may be used for the development or execution of virtual experiences 1506. For example, virtual experience engine 1504 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 1504 may generate commands that help compute and render the virtual experience (e.g., rendering commands, collision commands, physics commands, etc.) In some implementations, virtual experience applications 1512 of client devices 1510, respectively, may work independently, in collaboration with virtual experience engine 1504 of online virtual experience server 1502, or a combination of both.

In some implementations, both the online virtual experience server 1502 and client devices 1510 may execute a virtual experience engine/application (1504 and 1512, respectively). The online virtual experience server 1502 using virtual experience engine 1504 may perform some or all the virtual experience engine functions (e.g., generate physics commands, rendering commands, etc.), or offload some or all the virtual experience engine functions to virtual experience engine 1504 of client device 1510. In some implementations, each virtual experience 1506 may have a different ratio between the virtual experience engine functions that are performed on the online virtual experience server 1502 and the virtual experience engine functions that are performed on the client devices 1510. For example, the virtual experience engine 1504 of the online virtual experience server 1502 may be used to generate physics commands in cases where there is a collision between at least two virtual experience objects, while the additional virtual experience engine functionality (e.g., generate rendering commands) may be offloaded to the client device 1510. In some implementations, the ratio of virtual experience engine functions performed on the online virtual experience server 1502 and client device 1510 may be changed (e.g., dynamically) based on virtual experience engagement conditions. For example, if the number of users engaging in a particular virtual experience 1506 exceeds a threshold number, the online virtual experience server 1502 may perform one or more virtual experience engine functions that were previously performed by the client devices 1510.

For example, users may be playing a virtual experience 1506 on client devices 1510, and may send control instructions (e.g., user inputs, such as right, left, up, down, user election, or character position and velocity information, etc.) to the online virtual experience server 1502. Subsequent to receiving control instructions from the client devices 1510, the online virtual experience server 1502 may send experience instructions (e.g., position and velocity information of the characters participating in the group experience or commands, such as rendering commands, collision commands, etc.) to the client devices 1510 based on control instructions. For instance, the online virtual experience server 1502 may perform one or more logical operations (e.g., using virtual experience engine 1504) on the control instructions to generate experience instruction(s) for the client devices 1510. In other instances, online virtual experience server 1502 may pass one or more or the control instructions from one client device 1510 to other client devices (e.g., from client device 1510a to client device 1510b) participating in the virtual experience 1506. The client devices 1510 may use the experience instructions and render the virtual experience for presentation on the displays of client devices 1510.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 1502. In other implementations, the control instructions may be sent from a client device 1510 to another client device (e.g., from client device 1510b to client device 1510n), where the other client device generates experience instructions using the local virtual experience engine 1504. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 1510 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 1510 may be used.

In some implementations, each client device 1510 may include an instance of the virtual experience application 1512, respectively. In one implementation, the virtual experience application 1512 may permit users to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 1510 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 1502 as well as interact with online virtual experience server 1502 (e.g., engage in virtual experiences 1506 hosted by online virtual experience server 1502). As such, the virtual experience application may be provided to the client device(s) 1510 by the online virtual experience server 1502. In another example, the virtual experience application may be an application that is downloaded from a server.

In some implementations, each developer device 1530 may include an instance of the virtual experience application 1532, respectively. In one implementation, the virtual experience application 1532 may permit a developer user(s) to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 1530 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 1532 may be an online virtual experience server application for users to build, create, edit, upload content to the online virtual experience server 1502 as well as interact with online virtual experience server 1502 (e.g., provide and/or engage in virtual experiences 1506 hosted by online virtual experience server 1502). As such, the virtual experience application may be provided to the developer device(s) 1530 by the online virtual experience server 1502. In another example, the virtual experience application 1532 may be an application that is downloaded from a server. Virtual experience application 1532 may be configured to interact with online virtual experience server 1502 and obtain access to user credentials, user currency, etc. for one or more virtual experiences 1506 developed, hosted, or provided by a virtual experience developer.

In some implementations, a user may login to online virtual experience server 1502 via the virtual experience application. The user may access a user account by providing user account information (e.g., username and password) where the user account is associated with one or more characters available to participate in one or more virtual experiences 1506 of online virtual experience server 1502. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 1502 can also be performed by the client device(s) 1510, or a server, in other implementations if appropriate. In addition, the functionality attributed to a particular component can be performed by different or multiple components operating together. The online virtual experience server 1502 can also be accessed as a service provided to other systems or devices through suitable application programming interfaces (APIs), and thus is not limited to use in websites.

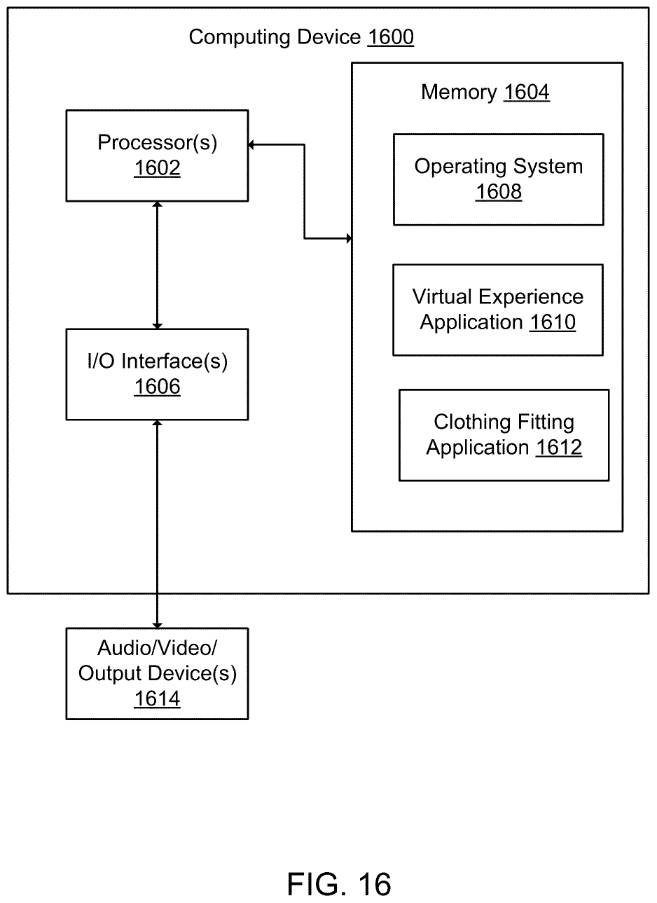

### FIG. 16—Example Computing Device

FIG. 16 is a block diagram that illustrates an example computing device 1600 which may be used to implement one or more features described herein, in accordance with some implementations. In one example, computing device 1600 may be used to implement a computer device (e.g., 1502 and/or 1510 of FIG. 15), and perform appropriate method implementations described herein. Computing device 1600 can be any suitable computer system, server, or other electronic or hardware device. For example, the computing device 1600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1600 includes a processor 1602, a memory 1604, input/output (I/O) interface 1606, and audio/video input/output devices 1614.

Processor 1602 can be one or more processors and/or processing circuits to execute program code and control basic operations of the computing device 1600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1604 is typically provided in computing device 1600 for access by the processor 1602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1602 and/or integrated therewith. Memory 1604 can store software operating on the computing device 1600 by the processor 1602, including an operating system 1608, a virtual experience application 1610, a clothing fitting application 1612, and other applications (not shown). In some implementations, virtual experience application 1610 and/or clothing fitting application 1612 can include instructions that enable processor 1602 to perform the functions (or control the functions of) described herein, e.g., some or all of the methods described with respect to FIGS. 6-14.

For example, virtual experience application 1610 can include a clothing fitting application 1612, which as described herein can layer multiple layers of clothing onto an avatar and render the avatar within an online virtual experience server (e.g., 1502). Elements of software in memory 1604 can alternatively be stored on any other suitable storage location or computer-readable medium. In addition, memory 1604 (and/or other connected storage device(s)) can store instructions and data used in the features described herein. Memory 1604 and any other type of storage (magnetic disk, optical disk, magnetic tape, or other tangible media) can be considered “storage” or “storage devices.”

I/O interface(s) 1606 can provide functions to enable interfacing the computing device 1600 with other systems and devices. For example, network communication devices, storage devices (e.g., memory and/or data store 1520), and input/output devices can communicate via I/O interface(s) 1606. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 16 shows one block for each of processor 1602, memory 1604, I/O interface(s) 1606, and software blocks of operating system 1608, virtual experience application 1610, and clothing fitting application 1612. These blocks may represent one or more processors or processing circuitries, operating systems, memories, I/O interfaces, applications, and/or software engines. In other implementations, computing device 1600 may not have all of the components shown and/or may have other elements including other types of elements instead of, or in addition to, those shown herein. While the online virtual experience server 1502 is described as performing operations as described in some implementations herein, any suitable component or combination of components of online virtual experience server 1502 or similar system, or any suitable processor or processors associated with such a system, may perform the operations described.

A user device can also implement and/or be used with features described herein. Example user devices can be computer devices including some similar components as the computing device 1600, e.g., processor(s) 1602, memory 1604, and I/O interface(s) 1606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1614, for example, can be connected to (or included in) the computing device 1600 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 600, 700, 800, 900, 1000, 1100, 1200, 1300, and 1400) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (Saas) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to provide a three-dimensional (3D) avatar with multi-layered clothing in a 3D virtual environment, the computer-implemented method comprising:
providing the avatar in the 3D virtual environment, the avatar having an avatar body to be layered with an inner garment and an outer garment;
layering the inner garment onto the avatar body, wherein the layering includes:
fitting the inner garment onto the avatar body; and
deforming, using a linear cage deformer technique, an outer cage of the inner garment based on one or more of an outer cage of the avatar body and an inner cage of the inner garment;
layering the outer garment onto the inner garment, wherein the layering includes:
fitting the outer garment onto the inner garment based on the deformed outer cage of the inner garment and an inner cage of the outer garment; and
deforming, using the linear cage deformer technique, an outer cage of the outer garment based on one or more of the deformed outer cage of the inner garment and the inner cage of the outer garment; and
rendering the avatar body with the inner garment and the outer garment layered thereon.

2. The computer-implemented method of claim 1, wherein deforming the outer cage of the inner garment comprises:
identifying, for at least one outer cage vertex of the outer cage of the inner garment, a single corresponding vertex on both the outer cage of the avatar body and on the inner cage of the inner garment;
generating, using triangles that share the single corresponding vertex, a local coordinate frame of the inner cage of the inner garment and a local coordinate frame of the outer cage of the avatar body; and
adjusting a position of the at least one outer cage vertex of the outer cage of the inner garment to deform the outer cage of the inner garment using a difference between the local coordinate frame of the inner cage of the inner garment and the local coordinate frame of the outer cage of the avatar body.

3. The computer-implemented method of claim 1, wherein deforming the outer cage of the inner garment causes the outer garment to conform to a shape of the avatar body and a shape of the fitted inner garment.

4. The computer-implemented method of claim 1, wherein the outer cage of the inner garment, the inner cage of the outer garment, and the outer cage of the outer garment share a standardized UV layout usable to determine correspondence information between the outer cage of the inner garment and the inner cage of the outer garment, and wherein deforming the outer cage of the outer garment is based on the correspondence information.

5. The computer-implemented method of claim 1, wherein the computer-implemented method further comprises:
identifying, for at least one outer cage vertex of the outer cage of the outer garment, a single corresponding vertex on both the outer cage of the inner garment and on the inner cage of the outer garment;
generating, using triangles that share the single corresponding vertex, a local coordinate frame of the inner cage of the outer garment and a local coordinate frame of the outer cage of the inner garment; and
adjusting a position of the at least one outer cage vertex of the outer cage of the outer garment to deform the outer cage of the outer garment using a difference between the local coordinate frame of the inner cage of the outer garment and the local coordinate frame of the outer cage of the inner garment.

6. The computer-implemented method of claim 5, wherein adjusting the position of the at least one outer cage vertex of the outer cage of the outer garment preserves an original spacing and alignment between the inner cage of the outer garment and the outer cage of the outer garment while deforming the outer cage of the outer garment.

7. The computer-implemented method of claim 1, wherein deforming the outer cage of the inner garment using the linear cage deformer technique comprises:
determining a first dataset that describes a volume taken up by the avatar body prior to the fitting the inner garment onto the avatar body and a second dataset that describes a volume taken up by the inner garment after the fitting over the avatar body;
calculating differences between corresponding values in the first dataset and in the second dataset; and
using sums calculated from the differences and the values in the second dataset to deform the outer cage of the inner garment.

8. The computer-implemented method of claim 1, wherein if there are three or more layers of garments, the computer-implemented method further comprises, for each layer:
iteratively calculating successive differences in volume between preceding successive garment layers;
accumulating the successive differences; and
deforming the layer based on the accumulated successive differences.

9. The computer-implemented method of claim 1, wherein the linear cage deformer technique comprises, to deform an outer cage of a garment based on an outer cage of a previous garment or avatar body portion:
iterating over garment cage triangles of the garment and summing vertex offsets and weights of the garment cage triangles; and
deforming the outer cage of the garment based on a deformed garment outer cage (GOC) position determined from iterating over vertices of the outer cage of the garment.

10. The computer-implemented method of claim 9, wherein iterating over garment cage triangles of the garment and summing vertex offsets and weights of the garment cage triangles comprises:
computing difference transforms from previous outer cage (POC) triangles of the previous garment or avatar body portion to corresponding garment inner cage (GIC) triangles of the garment; and
transforming vertices of GOC triangles of the garment based on corresponding difference transforms and updating vertex offsets and weights of the GOC triangles of the garment accordingly.

11. The computer-implemented method of claim 10, wherein computing difference transforms from the POC triangles of the previous garment or avatar body portion to corresponding GIC triangles comprises computing local three by three matrices for the POC triangles and local three by three matrices for the GIC triangles, and wherein the difference transforms are local difference (LD) three by three matrices calculated by multiplying the POC matrices by inverses of the GIC matrices.

12. The computer-implemented method of claim 11, wherein computing the local three by three matrices for POC and GIC triangles comprises, for corresponding triangles of the POC and GIC triangles:
finding a first vector and a second vector, where the first vector and the second vector are two triangle edges of the corresponding triangle;
finding a third vector that is a cross product of the first vector and the second vector;
normalizing the first vector, the second vector, and the third vector; and
obtaining the local three by three matrix as a matrix having the first vector, the second vector, and the third vector as basis vectors.

13. The computer-implemented method of claim 10, wherein transforming vertices of the GOC triangles based on corresponding difference transforms and updating vertex offsets and weights of the GOC triangles accordingly comprises, for vertices of the GOC triangles:
finding original local offset (LO) vectors for the vertices of the GOC triangles by calculating differences of corresponding GOC vertex positions and corresponding GIC vertex positions;
transforming the LO vectors by calculating products of local difference (LD) matrices for the corresponding GOC triangles, the original LO vectors, and areas of GIC triangles associated with the corresponding GOC triangles;
adding the transformed LO vectors to vertex offsets for the vertices of the GOC triangles; and
adding the areas of the GIC triangles to vertex weights for the vertices of the GOC triangles.

14. The computer-implemented method of claim 9, wherein deforming the outer cage of the garment based on a deformed garment outer cage (GOC) position determined from iterating over the vertices of the outer cage of the garment comprises:
finding, for vertices of the outer cage of the garment, final local offsets as previously summed vertex offsets divided by previously summed vertex weights; and
deforming the outer cage of the garment based on the deformed GOC position of the outer cage of the garment determined based on vertices obtained as previous outer cage (POC) positions summed with the final local offsets.

15. A non-transitory computer-readable medium with instructions stored thereon that, responsive to execution by a processing device, causes the processing device to perform operations comprising:
providing an avatar in a 3D virtual environment, the avatar having an avatar body to be layered with an inner garment and an outer garment;
layering the inner garment onto the avatar body, wherein the layering includes:
fitting the inner garment onto the avatar body; and
deforming, using a linear cage deformer technique, an outer cage of the inner garment based on one or more of an outer cage of the avatar body and an inner cage of the inner garment;
layering the outer garment onto the inner garment, wherein the layering includes:
fitting the outer garment onto the inner garment based on the deformed outer cage of the inner garment and an inner cage of the outer garment; and
deforming, using the linear cage deformer technique, an outer cage of the outer garment based on one or more of the deformed outer cage of the inner garment and the inner cage of the outer garment; and
rendering the avatar body with the inner garment and the outer garment layered thereon.

16. The non-transitory computer-readable medium of claim 15, wherein deforming the outer cage of the inner garment causes the outer garment to conform to a shape of the avatar body and a shape of the fitted inner garment.

17. The non-transitory computer-readable medium of claim 15, wherein the linear cage deformer technique comprises, to deform an outer cage of a garment based on an outer cage of a previous garment or avatar body portion:
iterating over garment cage triangles of the garment and summing vertex offsets and weights of the garment cage triangles; and
deforming the outer cage of the garment based on a deformed garment outer cage (GOC) position determined from iterating over vertices of the outer cage of the garment.

18. A system, comprising:
a memory with instructions stored thereon; and
a processing device, coupled to the memory, the processing device configured to access the memory and execute the instructions, wherein the instructions cause the processing device to perform operations comprising:
providing an avatar in a 3D virtual environment, the avatar having an avatar body to be layered with an inner garment and an outer garment;
layering the inner garment onto the avatar body, wherein the layering includes:
fitting the inner garment onto the avatar body; and
deforming, using a linear cage deformer technique, an outer cage of the inner garment based on one or more of an outer cage of the avatar body and an inner cage of the inner garment;
layering the outer garment onto the inner garment, wherein the layering includes:
fitting the outer garment onto the inner garment based on the deformed outer cage of the inner garment and an inner cage of the outer garment; and
deforming, using the linear cage deformer technique, an outer cage of the outer garment based on one or more of the deformed outer cage of the inner garment and the inner cage of the outer garment; and
rendering the avatar body with the inner garment and the outer garment layered thereon.

19. The system of claim 18, wherein deforming the outer cage of the inner garment causes the outer garment to conform to a shape of the avatar body and a shape of the fitted inner garment.

20. The system of claim 18, wherein the linear cage deformer technique comprises, to deform an outer cage of a garment based on an outer cage of a previous garment or avatar body portion:
iterating over garment cage triangles of the garment and summing vertex offsets and weights of the garment cage triangles; and
deforming the outer cage of the garment based on a deformed garment outer cage (GOC) position determined from iterating over vertices of the outer cage of the garment.
